(19) United States
(12) Patent Application Publication
(10) Pub. No.: US 2026/0226633 A1
(43) Pub. Date: Aug. 6, 2026

(54) TUBULAR PENETRATION ELECTRODE-BASED FLOW CELL REACTION SYSTEM AND OPERATION METHOD

(71) Applicant: SOUTHEAST UNIVERSITY, Nanjing (CN)

(72) Inventors: Chao LIU, Nanjing (CN); Weicong XU, Nanjing (CN); Rui XIAO, Nanjing (CN); Tao LI, Nanjing (CN); Xiangchen KONG, Nanjing (CN)

(73) Assignee: SOUTHEAST UNIVERSITY, Nanjing (CN)

(21) Appl. No.: 19/574,491

(22) Filed: Mar. 23, 2026

Related U.S. Application Data
(63) Continuation of application No. PCT/CN2024/132368, filed on Nov. 15, 2024.

(30) Foreign Application Priority Data
Dec. 4, 2023 (CN) 202311641588.4

(51) Int. Cl. C25B 9/15; C25B 1/23; C25B 1/27; C25B 3/03; C25B 3/09; C25B 3/25; C25B 3/26; C25B 9/015; C25B 9/19; C25B 11/032; C25B 11/042; C25B 15/023; C25B 15/08

(52) U.S. Cl. CPC C25B 9/15; C25B 1/23; C25B 1/27; C25B 3/03; C25B 3/09; C25B 3/25; C25B 3/26; C25B 9/015; C25B 9/19; C25B 11/032; C25B 11/042; C25B 15/023; C25B 15/087

(57) ABSTRACT

A tubular penetration electrode-based flow cell reaction system and operating method are provided. The system includes a flow cell reactor and a gas-liquid separation device. The reactor has an anode chamber and a cathode chamber separated by a proton exchange membrane. The cathode chamber contains linearly or array-arranged multi-channel tubular penetration electrodes with multiple gas channels and a porous layered tube wall. Each electrode outlet is closed, and reaction gas is fed to the inlet via a gas duct assembly, forcing the gas under pressure through the porous wall to the electrode surface to form a gas-liquid-solid interface. The gas-liquid separation device separates the mixture discharged from the cathode chamber, and the separated gas and liquid return to the electrodes and cathode chamber, respectively, to form a circulation loop. A detection point on the loop enables product recovery based on detection. The system supports efficient, stable electroreduction and industrial-scale use.

### CROSS REFERENCE TO THE RELATED APPLICATIONS

This application is a continuation application of International Application No. PCT/CN2024/132368, filed on November 15, 2024, which is based upon and claims priority to Chinese Patent Application No. 202311641588.4, filed on December 4, 2023, the entire contents of which are incorporated herein by reference.

### TECHNICAL FIELD

The present disclosure relates to the field of electrocatalytic technologies, and in particular to a tubular penetration electrode-based flow cell reaction system and operation method.

### BACKGROUND

The traditional flow electrolytic cells, as an energy conversion device, mainly convert a reaction gas of a cathode (CO, CO₂, N₂, nitrogen oxide, CO₂ and N₂ or CO₂ and nitrogen oxide) into a high-value-added product during an electrochemical process. Although significant progress has been made in electroreduction at present, the low solubility and long mass transfer distance of the reaction gas hinder the gas transport, leading to a very limited current density which is only dozens of mA/cm² far lower than the requirements of the industrial applications. In one strategy to solve the the problem, a highly active catalyst is coated on a microporous layer decorated with superhydrophobic polytetrafluoroethylene and conductive carbon particles to construct a gas diffusion electrode (GDE). The GDE is a porous membrane electrode which is integrated with a flow cell or membrane electrode assembly to promote the reaction gas to quickly diffuse to an active site, so as to enable the reaction to proceed under the current density of the industrial scale (≥300 mA/cm²), mitigating the mass transfer limitation of the reaction gas. However, in the long-term operation process of the traditional flow electrolytic cell system, the degradation of the GDE and the aging and loosening of a binder integrated in the GDE in long-term electrolysis can be observed. The problem existing in the GDE itself severely affects the efficient and stable operation of the system. Further, due to small surface/volume ratio of the GDE, the traditional flow electrolytic cell system can only carry out the lab-scale small experiments and is not applicable to large-scale experiments. Furthermore, in the reaction process of the traditional flow electrolytic cell, there is a large quantity of reaction gas escaping through the gas diffusion layer of the GDE into the electrolyte on the other side, leading to reaction gas loss and so on.

### SUMMARY

For the shortcomings of the prior arts, the present disclosure provides a tubular penetration electrode-based flow cell reaction system and operation method, aiming to realize efficient conversion, stable operation and large-scale application of a flow electrolytic cell.

The technical solution of the present disclosure is as follows:

A tubular penetration electrode-based flow cell reaction system, including: a flow cell reactor internally provided with a cathode chamber and an anode chamber separated by a proton exchange membrane, wherein the cathode chamber is connected with a reaction gas input tube, a cathode electrolyte input tube and a gas-liquid output tube which are respectively used to input a reaction gas and a cathode electrolyte and output a post-reaction gas-liquid product, the cathode chamber is internally provided with a gas duct assembly and multiple multi-channel tubular penetration electrodes, an inlet of the gas duct assembly is connected with an outlet of the reaction gas input tube, multiple outlets are disposed on the gas duct assembly to correspondingly connect with inlets of the multiple multi-channel tubular penetration electrodes, and outlets of the multi-channel tubular penetration electrodes are closed; the anode chamber is connected with an anode electrolyte input tube for inputting an anode electrolyte, the anode chamber is internally provided with an anode electrode, and the anode electrode and the multi-channel tubular penetration electrodes are respectively connected to both ends of a power source;

the multiple multi-channel tubular penetration electrodes are arranged linearly or distributed in an array;

the multi-channel tubular penetration electrodes are made of a single metal material by phase inversion and sintering method and have multiple channels with one end closed for gas transfer and diffusion and tube walls being porous layered wall structure; or, on the basis of the single metal material, catalytic active sites of a surface of the electrodes are regulated by surface reconstruction;

further including a gas-liquid separation device for performing gas-liquid separation on a post-reaction gas-liquid mixture output by the cathode chamber, wherein the gas-liquid separation device is provided with a gas-liquid inlet, a gas outlet and a liquid outlet, the gas-liquid inlet is connected with an outlet of the gas-liquid output tube, the gas outlet is connected with the reaction gas input tube through a first connection tube and then connected with an inlet of the gas duct assembly, and the liquid outlet is connected with the cathode electrolyte input tube through a second connection tube and then connected with the cathode chamber;

a first circulating pump, a gas detection point and a first three-way valve are disposed sequentially on the first connection tube, and another outlet of the first three-way valve is connected with a gas product collection end;

a second circulating pump, a liquid detection point and a second three-way valve are disposed sequentially on the second connection tube, and another outlet of the second three-way valve is connected with a liquid product collection end;

the reaction gas includes one of CO, CO₂, N₂, nitrogen oxide, mixture of CO₂ and N_{2,} and mixture of CO₂ and nitrogen oxide;

the anode electrolyte and the cathode electrolyte are an acid electrolyte or alkaline electrolyte.

Furthermore, the technical solution is as follows:

the surface reconstruction includes doping carbon nanotube, introducing ZIF material, doping another single metal or doping another heteroatom into a single metal substrate, or performing surface modification on the multi-channel tubular penetration electrodes of the single metal substrate by in-situ electrochemical etching or in-situ wet-chemical method.

The multiple multi-channel tubular penetration electrodes are arranged linearly or distributed in an array;

The gas duct assembly includes a main tube and multiple branch tubes connected and parallel-connected with the main tube, and an outlet of the gas duct assembly is located on an opening end of each branch tube.

The gas duct assembly is a metallic member connected with the power source by a wire.

A first inlet of the reaction gas input tube is connected with an outlet of the first connection tube, a second inlet of the reaction gas input tubes connected with an external reaction gas source; a first electric valve, a mass flowmeter and a gas pressure meter are disposed on the reaction gas input tube.

An inlet of the cathode electrolyte input tube is connected with a cathode electrolyte storage tank, and a second electric valve is disposed on the cathode electrolyte input tube.

An inlet of the anode electrolyte input tube is connected with an anode electrolyte storage tank, and a third electric valve and a liquid pressure meter are disposed on the anode electrolyte input tube.

The anode chamber is further provided with an exhaust tube to output a gas generated by reaction in the anode chamber.

An operation method of the tubular penetration electrode-based flow cell reaction system, including the following steps:

a cathode electrolyte is input into the cathode chamber through the cathode electrolyte input tube, an anode electrolyte is input into the anode chamber through the anode electrolyte input tube, an external reaction gas is input into multiple multi-channel tubular penetration electrodes through the reaction gas input tube and the gas duct assembly, and the power source is turned on to enable the reaction gas to flow into channels of the multi-channel tubular penetration electrodes and evenly penetrate to a surface of the electrodes through the porous layered wall for electroreduction reaction, and discharge the escaping reaction gas, electrolyte and electroreduction product into the gas-liquid separation device through the gas-liquid output tube for gas-liquid separation;

the gas subjected to gas-liquid separation returns through the first connection tube, the reaction gas input tube, the gas duct assembly into the multi-channel tubular penetration electrodes to continue participation in electroreduction reaction to form a closed cycle circuit;

the liquid subjected to gas-liquid separation returns through the second connection tube and the cathode electrolyte input tube into the cathode chamber to form a closed cycle circuit;

when the product is a gas, a concentration of the reaction gas is detected by the gas detection point; when the concentration of the reaction gas is less than a first set value, the first three-way valve is switched to transport the gas in the first connection tube to the external gas product collection end while adjusting a flow rate of the external reaction gas to maintain a total pressure inside the multi-channel tubular penetration electrodes unchanged until the gas detection point detects the concentration of the reaction gas is greater than a second set value; then the first three-way valve is switched again to enable the gas in the first connection tube to re-enter the multi-channel tubular penetration electrodes for participation in the electroreduction reaction;

when the product is a liquid, a concentration of the liquid product is detected by the liquid detection point; when the concentration of the liquid product is greater than a third set value, the second three-way valve is switched to transport the liquid in the second connection tube to the external liquid product collection end while replenishing the cathode electrolyte to the cathode chamber through the cathode electrolyte input tube until the liquid detection point detects the concentration of the liquid product is less than a fourth set value; then the second three-way valve is switched again to enable the liquid in the second connection tube to re-enter the cathode chamber;

H⁺ generated by electrolysis of the anode electrolyte enters the cathode chamber through the proton exchange membrane to provide sufficient H⁺ for the electroreduction reaction in the cathode chamber while O₂ generated in the anode chamber is discharged through the exhaust tube.

the multi-channel tubular penetration electrodes made of corresponding materials enable CO to be directionally converted into methane, methanol, formic acid, ethane, ethylene, ethanol or acetic acid, enable CO₂ to be directionally converted into CO, methane, methanol, formic acid, ethane, ethylene, ethanol or acetic acid, enable N₂ and nitrogen oxide to directionally converted into ammonia gas or ammonia water, and enable the mixture of CO₂ and N₂ and the mixture of CO₂ and nitrogen oxide to be directionally converted into urea.

The present disclosure has the following beneficial effects:

The present disclosure realizes efficient conversion, stable operation and large-scale application of the system under the industrial-level current density, and has the following advantages:
1. Compared with the traditional plate electrodes, the multi-channel tubular penetration electrodes in the present disclosure has a high ratio of surface area to volume and a tubular penetration electrode array facilitating extending a single tubular penetration electrode to multiple well-arranged tubular penetration electrodes, realizing expansion of the electroreduction reaction scale.
2. Compared with the traditional plate flow cell reaction system, the tubular penetration electrode-based flow cell reaction system of the present disclosure is provided with a gas-liquid separation device and combines with automatic control modules and corresponding executing mechanisms including electric valve, three-way valve, gas-liquid detection point, pressure meter, and mass flowmeter and the like, to realize the automatic operation and efficiency gas-liquid product separation of the system; when the product enrichment concentration reaches an industrial purification concentration, the product can be automatically discharged, improving the automation degree of the system and reducing the labor consumption.
3. In the present disclosure, by changing the electrode material of the multi-channel tubular penetration electrodes and regulating the catalytic active sites of the electrode material, different high value-added products can be directionally prepared by electroreduction of multiple reaction gases.

Other features and advantages of the present disclosure will be set out in the subsequent specification and will partly become apparent from the specification or be understood by practice of the present disclosure.

### BRIEF DESCRIPTION OF THE DRAWINGS

FIG. 1 is a schematic diagram illustrating a system structure according to an embodiment of the present disclosure.

FIG. 2 is a longitudinal general sectional view of an arrangement structure of the multi-channel tubular penetration electrodes in FIG. 1.

FIG. 3 is a transverse sectional view of an arrangement structure of the multi-channel tubular penetration electrodes in FIG. 1.

In the drawings: 1. flow cell reactor; 2. gas-liquid separation device;

11. cathode chamber; 12. anode chamber; 13. proton exchange membrane; 14. power source;

21. rotary separator; 22. gas-liquid inlet; 23. gas outlet; 24. liquid outlet; 25. first circulating pump; 26. first three-way valve; 27. gas detection point; 28. second circulating pump; 29. second three-way valve; 210. liquid detection point, 211. first connection tube; and 212. second connection tube;

111. gas duct assembly; 112. multi-channel tubular penetration electrode; 113. reaction gas input tube; 114. cathode electrolyte input tube; 115. gas-liquid output tube; 116. external reaction gas source; 117. first electric valve; 118. mass flowmater; 119. gas pressure meter; 1110. cathode electrolyte storage tank; 1111. second electric valve; 1121. channel;

121. anode electrode; 122. anode electrolyte input tube; 123. exhaust tube; 124. anode electrolyte storage tank; 125. third electric valve, and 126. liquid pressure meter.

### DETAILED DESCRIPTION OF THE EMBODIMENTS

The specific implementations of the present disclosure will be described below in combination with drawings.

### Embodiment 1

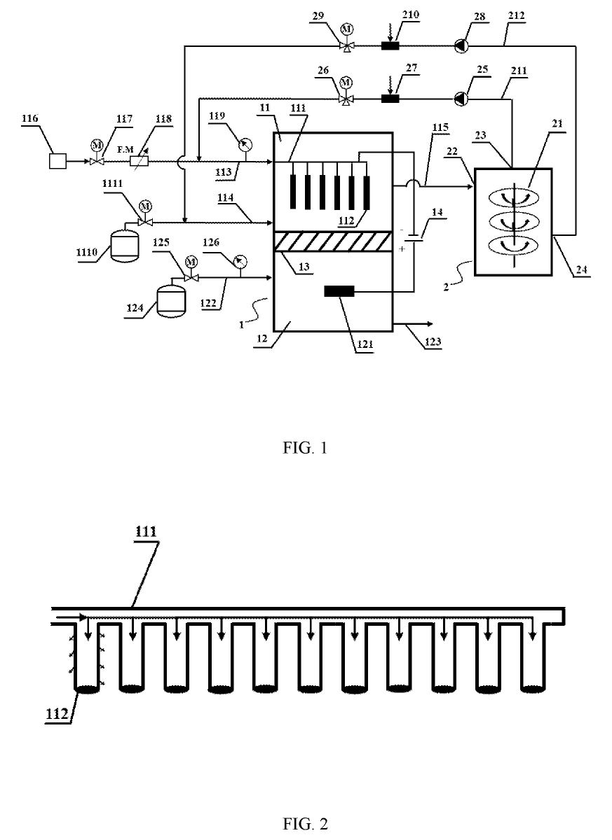

With reference to FIG. 1 this embodiment provides a tubular penetration electrode-based flow cell reaction system, including: a flow cell reactor 1) internally provided with a cathode chamber 11 and an anode chamber 12 separated by a proton exchange membrane 13, wherein the cathode chamber 11 is connected with a reaction gas input tube 113, a cathode electrolyte input tube 114 and a gas-liquid output tube 115 which are respectively used to input a reaction gas and a cathode electrolyte and output a post-reaction gas-liquid product, the cathode chamber 11 is internally provided with a gas duct assembly 111 and multiple multi-channel tubular penetration electrodes 112, an inlet of the gas duct assembly 111 is connected with an outlet of the reaction gas input tube 113, multiple outlets are disposed on the gas duct assembly 111 to correspondingly connect with inlets of the multiple multi-channel tubular penetration electrodes 112, and outlets of the multi-channel tubular penetration electrodes 112 are closed; the anode chamber 12 is connected with an anode electrolyte input tube 122 for inputting an anode electrolyte, the anode chamber 12 is internally provided with an anode electrode 121 (inert electrode), and the anode electrode 121 and the multi-channel tubular penetration electrodes 112 are respectively connected to both ends of a power source 14;

further including a gas-liquid separation device 2 for performing gas-liquid separation on a post-reaction gas-liquid mixture output by the cathode chamber 11, wherein the gas-liquid separation device 2 is provided with a gas-liquid inlet 22, a gas outlet 23 and a liquid outlet 24, the gas-liquid inlet 22 is connected with an outlet of the gas-liquid output tube 115, the gas outlet 23 is connected with the reaction gas input tube 113 through a first connection tube 211 and then connected with an inlet of the gas duct assembly 111, and the liquid outlet 24 is connected with the cathode electrolyte input tube 114 through a second connection tube 212 and then connected with the cathode chamber 11;

the first circulating pump 25, a gas detection point 27 and a first three-way valve 26 are disposed sequentially on the first connection tube 211, and another outlet of the first three-way valve 26 is connected with a gas product collection end;

the second circulating pump 28, a liquid detection point 210 and a second three-way valve 29 are disposed sequentially on the second connection tube 212, and another outlet of the second three-way valve 29 is connected with a liquid product collection end.

Specifically, a first inlet of the reaction gas input tube 113 is connected with an outlet of the first connection tube 211, a second inlet of the reaction gas input tube 113 is connected with an external reaction gas source 116; a first electric valve 117, a mass flowmeter 118 and a gas pressure meter 119 are disposed on the reaction gas input tube 113.

Specifically, an inlet of the cathode electrolyte input tube 114 is connected with a cathode electrolyte storage tank 1110, and a second electric valve 1111 is disposed on the cathode electrolyte input tube 114.

Specifically, an inlet of the anode electrolyte input tube 122 is connected with an anode electrolyte storage tank 124, and a third electric valve 125 and a liquid pressure meter 126 are disposed on the anode electrolyte input tube 122.

Specifically, the anode chamber 12 is further provided with an exhaust tube 123 to output a gas generated by reaction in the anode chamber 12.

Specifically, the gas-liquid separation device 2 is internally provided with a rotary separator 21 to perform separation on the post-reaction gas-liquid mixture by rotation.

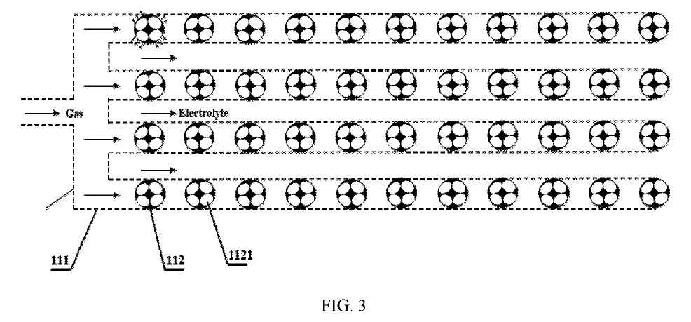

With reference to FIG. 2 and FIG. 3, the multiple multi-channel tubular penetration electrodes 112 are arranged linearly or distributed in an array.

The gas duct assembly 111 includes a main tube and multiple branch tubes connected and parallel-connected with the main tube, and an outlet of the gas duct assembly 111 is located on an opening end of each branch tube; the gas duct assembly 111 is a metallic member connected with the power source 14 by a wire.

where the multi-channel tubular penetration electrodes 112 in this embodiment are prepared by phase inversion and sintering method, and the specific preparation method includes:

mixing a silver powder, N-methylpyrrolidone and a binder at a ratio and then ball-milling to prepare a membrane forming solution;

performing vacuum degassing treatment on the membrane forming solution;

using the vacuum-degassed membrane forming solution as a shell solution, and an coagulant as a core solution and at the same time, extruding by a spinneret of a spinning device into water to obtain a precursor of the multi-channel tubular penetration electrodes;

performing sintering treatment on the precursor at high temperature and then performing reduction treatment in a hydrogen atmosphere to form the multi-channel tubular penetration electrodes of silver-based material, which are used to realize directional conversion into CO by electrocatalytic CO₂ reduction;

wherein the obtained multi-channel tubular penetration electrodes have multiple tubular channels with a tube wall being porous layered wall.

The multi-channel tubular penetration electrodes 112 have multiple channels 1121 four in this embodiment, and an inlet of the channels 1121 is connected with an outlet of the gas duct assembly 111, with an outlet of the channels 1121 closed; the wall surface of the multi-channel tubular penetration electrodes is a porous layered wall structure, namely, the tube wall has multi-layered and porous characteristics, helping gas penetration.

During working, a reaction gas is introduced into the channels 1121 of the multi-channel tubular penetration electrodes 112 through the gas duct assembly 111; since the outlet of the channels 1121 is closed, the reaction gas flows along the channels 1121 and evenly penetrates to a surface of the electrodes through the porous layered wall, with the direction of the gas flow as shown by the arrow in FIGS. 2 and 3. A gas-liquid-solid reaction interface is formed on the surface of the multi-channel tubular penetration electrodes 112, and the reaction gas undergoes electroreduction reaction on the reaction interface.

This embodiment further provides an operation method of the tubular penetration electrode-based flow cell reaction system, where the multi-channel tubular penetration electrodes 112 are made of silver-based material to realize directional conversion of CO₂ into CO. The method includes the following steps:

the second electric valve 1111 is turned on to enable the cathode electrolyte in the cathode electrolyte storage tank 1110 to be input into the cathode chamber 11 to full through the cathode electrolyte input tube 114 so that the multi-channel tubular penetration electrodes 112 are immersed therein;

the third electric valve 125 is turned on to enable the anode electrolyte in the anode electrolyte storage tank 124 to be input into the anode chamber 12 to full through the anode electrolyte input tube 122 so that the anode electrode 121 is immersed therein;

the first electric valve 117 is turned on to enable the reaction gas CO₂ of the external reaction gas source 116 to be input into the multiple multi-channel tubular penetration electrodes 112 through the reaction gas input tube 113 and the gas duct assembly 111; the power source 14 is turned on to enable the reaction gas to flow into the channels 1121 of the multi-channel tubular penetration electrodes 112 and evenly penetrate to a surface of the electrodes through the porous layered wall for electroreduction reaction, and discharge the escaping reaction gas, electrolyte and electroreduction product into the gas-liquid separation device 2 for gas-liquid separation through the gas-liquid output tube 115 ;

the gas subjected to gas-liquid separation returns through the first connection tube 211, the reaction gas input tube 113, the gas duct assembly 111 into the multi-channel tubular penetration electrodes 112 under the action of the first circulating pump 25 to continue participation in electroreduction reaction to form a closed cycle circuit;

a concentration of the reaction gas is detected by the gas detection point 27; when the concentration of the reaction gas CO₂ is less than a first set value set to 5% in this embodiment, the first three-way valve 26 is switched to transport the gas product in the first connection tube 211 to the external gas product collection end while automatically adjusting a gas flow rate of the external reaction gas source 116 by the mass flowmeter 118 to maintain a total pressure inside the multi-channel tubular penetration electrodes 112 unchanged until the gas detection point 27 detects the concentration of the reaction gas CO₂ is greater than a second set value set to 99% in this embodiment; then the first three-way valve 26 is switched again to enable the gas in the first connection tube 211 to re-enter, through the reaction gas input tube 113 under the action of the first circulating pump 25, the multi-channel tubular penetration electrodes 112 for participation in the electroreduction reaction;

the liquid electrolyte subjected to gas-liquid separation returns through the second connection tube 212 and the cathode electrolyte input tube 114 into the cathode chamber 11 under the action of the second circulating pump 28 to form a closed cycle circuit;

H⁺ generated by electrolysis of the anode electrolyte enters the cathode chamber 11 through the proton exchange membrane 13 to provide sufficient H⁺ for the electroreduction reaction in the cathode chamber 11 while O₂ generated in the anode chamber 12 is discharged through the exhaust tube 123; the third electric valve 125 performs automatic adjustment in real time so that the anode electrolyte in the anode electrolyte storage tank 124 is replenished to the anode chamber 12.

### Embodiment 2

The tubular penetration electrode-based flow cell reaction system in this embodiment differs from the embodiment 1 in that:

the electrode material of the multi-channel tubular penetration electrodes is a copper-based material, and the carbon nanotube is mixed with the membrane forming solution, and the subsequent steps are the same as above; thus, the carbon material is used as a conductive scaffold for copper nanoparticles to realize surface reconstruction of the above multi-channel tubular penetration electrodes of copper-based material, and the electrodes with the reconstructed surface can realize directional conversion into CH₄ by catalytic CO₂ electroreduction.

The operation method in this embodiment is the same as that in the embodiment 1, and the employed reaction gas is also CO_{2,} except for the difference below: the copper-based multi-channel tubular penetration electrodes doped with the carbon nanotubes are used to realize directional conversion into CH₄ by CO₂ electrocatalysis.

### Embodiment 3

The tubular penetration electrode-based flow cell reaction system in this embodiment differs from the embodiment 1 in that:

the electrode material of the multi-channel tubular penetration electrodes is a cooper-based material, and the structure of the surface of the copper-based material is modified by in-situ electrochemical etching to obtain a valley-like catalytic active site.

The in-situ electrochemical etching method specifically includes: placing the obtained multi-channel tubular penetration electrodes of copper-based material into an acid electrolyte and applying a voltage of 2V vs. Ag/AgCl to perform electrochemical etching so as to construct a valley-like structure on the surface of the electrode material.

The operation method of this embodiment is the same as that in the embodiment 1 and the employed reaction gas is also CO₂, except for the difference below: the copper-based multi-channel tubular penetration electrodes undergoing in-situ electrochemical etching are used to realize directional conversion into C₂H₄ by CO₂ electrocatalysis.

### Embodiment 4

The tubular penetration electrode-based flow cell reaction system in this embodiment differs from the embodiment 1 in that:

the electrode material of the multi-channel tubular penetration electrodes is a copper-based material, and the structure of the surface of the copper-based material is modified by in-situ wet chemical method to obtain a catalytic active site with a nanocavity structure.

The in-situ wet chemical method specifically includes: placing the obtained multi-channel tubular penetration electrodes of copper-based material into an acid etching solution to perform wet chemical reaction for 60s so as to inductively generate a nanocavity structure on the surface of the electrode material.

The operation method of this embodiment is the same as that in the embodiment 1 and the employed reaction gas is also CO_{2,} except for the difference below: the copper-based multi-channel tubular penetration electrodes undergoing in-situ wet chemical reaction are used to realize directional conversion into C₂H₆ by CO₂ electrocatalysis.

### Embodiment 5

The tubular penetration electrode-based flow cell reaction system in this embodiment differs from the embodiment 1 in that:

the electrode material of the multi-channel tubular penetration electrodes is a cooper-based material, and the structure of the surface of the copper-based material is modified by in-situ electrochemical etching to obtain a valley-like catalytic active site.

The operation method of this embodiment is the same as that in the embodiment 1, except for the difference below: the employed reaction gas is CO_{,} and the copper-based multi-channel tubular penetration electrodes undergoing in-situ electrochemical etching are used to realize directional conversion into CH₄ by COelectrocatalysis.

### Embodiment 6

The tubular penetration electrode-based flow cell reaction system in this embodiment differs from the embodiment 1 in that:

the electrode material of the multi-channel tubular penetration electrodes is a copper-based material, and the structure of the surface of the copper-based material is modified by in-situ wet chemical method to obtain a catalytic active site with a nanocavity structure.

The operation method of this embodiment is the same as that in the embodiment 1, except for the difference below: the employed reaction gas is CO_{,} and the copper-based multi-channel tubular penetration electrodes undergoing in-situ wet chemical reaction are used to realize directional conversion into C₂H₄ by COelectrocatalysis.

### Embodiment 7

The tubular penetration electrode-based flow cell reaction system in this embodiment differs from the embodiment 1 in that:

the electrode material of the multi-channel tubular penetration electrodes is a copper-based material, and graphitic carbon nitride is mixed with the membrane forming solution, and the subsequent steps are the same as in the embodiment 1; by this method, nitrogen atoms are doped into the copper-based multi-channel tubular penetration electrodes to obtain a catalytic active site doped with nitrogen atoms.

The operation method of this embodiment is the same as that in the embodiment 1, except for the difference below: the employed reaction gas is CO_{,} and the copper-based multi-channel tubular penetration electrodes doped with nitrogen atoms are used to realize directional conversion into C₂H₆ by COelectrocatalysis.

### Embodiment 8

The tubular penetration electrode-based flow cell reaction system in this embodiment differs from the embodiment 1 in that:

the electrode material of the multi-channel tubular penetration electrodes is a tin-based material, and ZIF material is introduced in the tin-based material by impregnation to modify its surface structure and obtain a catalytic active site with rich porous structures.

ZIF material is introduced in the tin-based material to modify its surface structure, which specifically includes: placing the obtained multi-channel tubular penetration electrodes of tin-based material in the impregnation solution of the ZIF material for impregnation reaction so as to produce rich porous structures on the surface of the electrode material.

In the operation method of the tubular penetration electrode-based flow cell reaction system in this embodiment, the multi-channel tubular penetration electrodes with the surface of the tin-based material reconstructed by introducing ZIF material realize directional conversion of NO into ammonia water or ammonia gas, which includes the following steps:

the second electric valve 1111 is turned on to enable the cathode acid or alkaline electrolyte in the cathode electrolyte storage tank 1110 to be input into the cathode chamber 11 to full through the cathode electrolyte input tube 114 so that the multi-channel tubular penetration electrodes 112 are immersed therein;

the third electric valve 125 is turned on to enable the anode acid or alkaline electrolyte in the anode electrolyte storage tank 124 to be input into the anode chamber 12 to full through the anode electrolyte input tube 122 so that the anode electrode 121 is immersed therein;

the first electric valve 117 is turned on to enable the reaction gas NOof the external reaction gas source 116 to be input into the multiple multi-channel tubular penetration electrodes 112 through the reaction gas input tube 113 and the gas duct assembly 111; the power source 14 is turned on to enable the reaction gas to flow into the channels 1121 of the multi-channel tubular penetration electrodes 112 and evenly penetrate to a surface of the electrodes through the porous layered wall for electroreduction reaction, and discharge the escaping reaction gas, electrolyte and electroreduction product ammonia water or ammonia gas into the gas-liquid separation device 2 for gas-liquid separation through the gas-liquid output tube 115;

when the cathode and anode electrolytes are an acid electrolyte, the product of the NO electroreduction mainly is a liquid-phase product ammonia water. Therefore, the liquid separated out by the gas-liquid separation device 2 returns into the cathode chamber 11 through the second connection tube 212 and the cathode electrolyte input tube 114 under the action of the second circulating pump 28 to form a closed cycle circuit; the concentration of the liquid product is detected by the liquid detection point 210; when the concentration of the liquid product NH₄⁺ is greater than or equal to a third set value set to 0.414 g/mL in this embodiment, the second three-way valve 29 is switched to transport the liquid in the second connection tube 212 to the external liquid product collection end and at the same time, the second electric valve 1111 automatically adjusts to replenish the cathode electrolyte into the cathode chamber 11 through the cathode electrolyte input tube 114 until the liquid detection point 210 detects that the concentration of the liquid product NH₄⁺ is less than a fourth set value set to 1 μg/mL in this embodiment, and then the second three-way valve 29 is switched again to enable the liquid in the second connection tube 212 to re-enter the cathode chamber 11 through the cathode electrolyte input tube 114;

when the cathode and anode electrolytes are an alkaline electrolyte, the product of the NO electroreduction mainly is a gas-phase product ammonia gas. Therefore, the gas separated out by the gas-liquid separation device 2 returns into the multi-channel tubular penetration electrodes 112 through the first connection tube 211, the reaction gas input tube 113 and the gas duct assembly 111 to continue participation in electroreduction reaction to form a closed cycle circuit; when the gas detection point 27 detects that the concentration of the reaction gas NO is less than a first set value set to 5% in this embodiment, the first three-way valve 26 switches to collect the gas product ammonia gas and at the same time, the mass flowmeter 118 automatically adjusts the flow rate of the external reaction gas source 116 to maintain a total pressure inside the multi-channel tubular penetration electrodes 112 unchanged until the gas detection point 27 detects the concentration of the reaction gas NO is greater than a second set value set to 99% in this embodiment; at this time, the first three-way valve 26 is switched again to enable the gas supplied by the first circulating pump 25 to re-enter the multi-channel tubular penetration electrodes 112 for participation in electroreduction reaction.

### Embodiment 9

The tubular penetration electrode-based flow cell reaction system in this embodiment differs from the embodiment 8 in that:

the electrode material of the multi-channel tubular penetration electrodes is a tin-based material, and a bimetallic catalytic site is constructed by introducing a copper metal material in the tin-based material.

The operation method of this embodiment is the same as that in the embodiment 8, except for the difference below: the employed reaction gas is N₂, and the tin-based multi-channel tubular penetration electrodes with bimetallic catalytic site are used to realize directional conversion into ammonia water or ammonia gas by N₂ electrocatalysis.

### Embodiment 10

The tubular penetration electrode-based flow cell reaction system in this embodiment differs from the embodiment 8 in that:

In the operation method of the tubular penetration electrode-based flow cell reaction system in this embodiment, the multi-channel tubular penetration electrodes are made of a copper-based material, and the construction of the bimetallic catalytic site by introducing a palladium metal material in the copper-based material realizes directional conversion of CO₂ and N₂ into urea, which includes the following steps:

the second electric valve 1111 is turned on to enable the cathode electrolyte in the cathode electrolyte storage tank 1110 to be input into the cathode chamber 11 to full through the cathode electrolyte input tube 114 so that the multi-channel tubular penetration electrodes 112 are immersed therein;

the third electric valve 125 is turned on to enable the anode electrolyte in the anode electrolyte storage tank 124 to be input into the anode chamber 12 to full through the anode electrolyte input tube 122 so that the anode electrode 121 is immersed therein.

the first electric valve 117 is turned on to enable the reaction gases CO₂ and N₂ of the external reaction gas source 116 to be input into the multiple multi-channel tubular penetration electrodes 112 through the reaction gas input tube 113 and the gas duct assembly 111; the power source 14 is turned on to enable the reaction gases to flow into the channels 1121 of the multi-channel tubular penetration electrodes 112 and evenly penetrate to a surface of the electrodes through the porous layered wall for electroreduction reaction, and discharge the escaping reaction gases CO₂ and N₂, electrolyte and electroreduction product urea into the gas-liquid separation device 2 for gas-liquid separation through the gas-liquid output tube 115;

the gas subjected to gas-liquid separation returns through the first connection tube 211, the reaction gas input tube 113, the gas duct assembly 111 into the multi-channel tubular penetration electrodes 112 under the action of the first circulating pump 25 to continue participation in electroreduction reaction to form a closed cycle circuit;

the liquid subjected to gas-liquid separation returns through the second connection tube 212 and the cathode electrolyte input tube 114 into the cathode chamber 11 under the action of the second circulating pump 28 to form a closed cycle circuit; a concentration of the liquid product is detected by the liquid detection point 210; when the liquid detection point 210 detects the concentration of the product urea is ≥1.05 g/mL, the second three-way valve 29 is switched to transport the liquid in the second connection tube 212 to the external liquid product collection end, at the same time, the second electric valve 1111 automatically adjusts to replenish the cathode electrolyte into the cathode chamber 11 through the cathode electrolyte input tube 114 until the liquid detectionpoint 210 detects the concentration of the liquid product urea is < 1 μg/mL, and then the second three-way valve 29 is switched again to enable the liquid in the second connection tube 212 to re-enter the cathode chamber 11 through the cathode electrolyte input tube 114;

H⁺ generated by electrolysis of the anode electrolyte enters the cathode chamber 11 through the proton exchange membrane 13 to provide sufficient H⁺ for the electroreduction reaction in the cathode chamber 11 while O₂ generated in the anode chamber 12 is discharged through the exhaust tube 123; the third electric valve 125 performs automatic adjustment in real time so that the anode electrolyte in the anode electrolyte storage tank 124 is replenished to the anode chamber 12.

### Embodiment 11

The tubular penetration electrode-based flow cell reaction system in this embodiment differs from the embodiment 10 in that:

the multi-channel tubular penetration electrodes are made of a copper-based material, and the structure of the surface of the copper-based material is modified by in-situ wet chemical method to obtain a catalytic active site with a nanocavity structure.

The operation method of this embodiment is the same as that in the embodiment 10 except for the difference below: the employed reaction gas is a mixture of CO₂ and NO, and obtaining the catalytic active site with the nanocavity structure by modifying the structure of the surface of the copper-based material by in-situ wet chemical method can realize directional conversion of CO₂ and NO into urea.

In the operation process of the system in each of the above embodiments, the electric valve performs real-time automatic adjustment to enable the electrolyte to be correspondingly replenished in time to the anode chamber 12 and the cathode chamber 11.

Persons of ordinary skills in the arts can understand that the above are only preferred embodiments of the present disclosure and shall not be used to limit the present disclosure. Although detailed descriptions are made to the present disclosure by referring to the preceding embodiments, those skilled in the arts can still make modifications to the technical solutions recorded in each embodiment or make equivalent replacement to part of the technical features therein. Any modifications, equivalent replacements and improvements and so on made within the spirit and principle of the present disclosure shall all be incorporated in the scope of protection of the present disclosure.

What is claimed is:

1. A tubular penetration electrode-based flow cell reaction system, comprising: a flow cell reactor internally provided with a cathode chamber and an anode chamber separated by a proton exchange membrane, wherein the cathode chamber is connected with a reaction gas input tube, a cathode electrolyte input tube and a gas-liquid output tube which are respectively used to input a reaction gas and a cathode electrolyte and output a post-reaction gas-liquid product, the cathode chamber is internally provided with a gas duct assembly and a plurality of multi-channel tubular penetration electrodes, an inlet of the gas duct assembly is connected with an outlet of the reaction gas input tube, a plurality of outlets are disposed on the gas duct assembly to correspondingly connect with inlets of the plurality of multi-channel tubular penetration electrodes, and outlets of the multi-channel tubular penetration electrodes are closed; the anode chamber is connected with an anode electrolyte input tube for inputting an anode electrolyte, the anode chamber is internally provided with an anode electrode, and the anode electrode and the multi-channel tubular penetration electrodes are respectively connected to both ends of a power source;
the plurality of multi-channel tubular penetration electrodes are arranged linearly or distributed in an array;
the multi-channel tubular penetration electrodes are made of a single metal material by phase inversion and sintering method and have a plurality of channels with one end closed for gas transfer and diffusion and tube walls being porous layered wall structure; or, on the basis of the single metal material, catalytic active sites of a surface of the electrodes are regulated by surface reconstruction;
the surface reconstruction comprises doping carbon nanotube, introducing ZIF material, doping another single metal or doping another heteroatom into a single metal substrate, or performing surface modification on the multi-channel tubular penetration electrodes of the single metal substrate by in-situ electrochemical etching or in-situ wet-chemical method;
further comprising a gas-liquid separation device for performing gas-liquid separation on a post-reaction gas-liquid mixture output by the cathode chamber, wherein the gas-liquid separation device is provided with a gas-liquid inlet, a gas outlet, and a liquid outlet, the gas-liquid inlet is connected with an outlet of the gas-liquid output tube, the gas outlet is connected with the reaction gas input tube through a first connection tube and then connected with the inlet of the gas duct assembly, and the liquid outlet is connected with the cathode electrolyte input tube through a second connection tube and then connected with the cathode chamber;
a first circulating pump, a gas detection point, and a first three-way valve are disposed sequentially on the first connection tube, and another outlet of the first three-way valve is connected with a gas product collection end;
a second circulating pump, a liquid detection point, and a second three-way valve are disposed sequentially on the second connection tube, and another outlet of the second three-way valve is connected with a liquid product collection end;
the reaction gas comprises one of CO, CO₂ N₂ nitrogen oxide, a mixture of CO₂ and N_{2,} and a mixture of CO₂ and nitrogen oxide;
the anode electrolyte and the cathode electrolyte are an acid electrolyte or alkaline electrolyte.

2. The tubular penetration electrode-based flow cell reaction system according to claim 1, wherein the gas duct assembly comprises a main tube and a plurality of branch tubes connected and parallel-connected with the main tube, and an outlet of the gas duct assembly is located on an opening end of each branch tube;
the gas duct assembly is a metallic member connected with the power source by a wire.

3. The tubular penetration electrode-based flow cell reaction system according to claim 1, wherein a first inlet of the reaction gas input tube is connected with an outlet of the first connection tube, a second inlet of the reaction gas input tube is connected with an external reaction gas source; a first electric valve, a mass flowmeter, and a gas pressure meter are disposed on the reaction gas input tube.

4. The tubular penetration electrode-based flow cell reaction system according to claim 1, wherein an inlet of the cathode electrolyte input tube is connected with a cathode electrolyte storage tank, and a second electric valve is disposed on the cathode electrolyte input tube.

5. The tubular penetration electrode-based flow cell reaction system according to claim 1, wherein an inlet of the anode electrolyte input tube is connected with an anode electrolyte storage tank, and a third electric valve and a liquid pressure meter are disposed on the anode electrolyte input tube.

6. The tubular penetration electrode-based flow cell reaction system according to claim 1, wherein the anode chamber is further provided with an exhaust tube to output a gas generated by reaction in the anode chamber.

7. The tubular penetration electrode-based flow cell reaction system according to claim 1, wherein the gas-liquid separation device is internally provided with a rotary separator to perform separation on the post-reaction gas-liquid mixture by rotation.

8. An operation method of the tubular penetration electrode-based flow cell reaction system according to claim 1, comprising the following steps:
the cathode electrolyte is input into the cathode chamber through the cathode electrolyte input tube, the anode electrolyte is input into the anode chamber through the anode electrolyte input tube, an external reaction gas is input into the plurality of multi-channel tubular penetration electrodes through the reaction gas input tube and the gas duct assembly, and the power source is turned on to enable the reaction gas to flow into the channels of the multi-channel tubular penetration electrodes and evenly penetrate to the surface of the electrodes through a porous layered wall for electroreduction reaction, and discharge escaping reaction gas, electrolyte, and electroreduction product into the gas-liquid separation device through the gas-liquid output tube for gas-liquid separation;
a gas subjected to gas-liquid separation returns through the first connection tube, the reaction gas input tube, the gas duct assembly into the multi-channel tubular penetration electrodes to continue participation in the electroreduction reaction to form a closed cycle circuit;
a liquid subjected to gas-liquid separation returns through the second connection tube and the cathode electrolyte input tube into the cathode chamber to form a closed cycle circuit;
when the product is a gas, a concentration of the reaction gas is detected by the gas detection point; when the concentration of the reaction gas is less than a first set value, the first three-way valve is switched to transport the gas in the first connection tube to the external gas product collection end while adjusting a flow rate of the external reaction gas to maintain a total pressure inside the multi-channel tubular penetration electrodes unchanged until the gas detection point detects the concentration of the reaction gas is greater than a second set value; then the first three-way valve is switched again to enable the gas in the first connection tube to re-enter the multi-channel tubular penetration electrodes for participation in the electroreduction reaction;
when the product is a liquid, a concentration of the liquid product is detected by the liquid detection point; when the concentration of the liquid product is greater than a third set value, the second three-way valve is switched to transport the liquid in the second connection tube to the external liquid product collection end while replenishing the cathode electrolyte to the cathode chamber through the cathode electrolyte input tube until the liquid detection point detects the concentration of the liquid product is less than a fourth set value; then the second three-way valve is switched again to enable the liquid in the second connection tube to re-enter the cathode chamber;
H⁺ generated by electrolysis of the anode electrolyte enters the cathode chamber through the proton exchange membrane to provide sufficient H⁺ for the electroreduction reaction in the cathode chamber while O₂ generated in the anode chamber is discharged through an exhaust tube.

9. The operation method according to claim 8, wherein the multi-channel tubular penetration electrodes made of corresponding materials enable CO to be directionally converted into methane, methanol, formic acid, ethane, ethylene, ethanol, or acetic acid, enable CO₂ to be directionally converted into CO, methane, methanol, formic acid, ethane, ethylene, ethanol, or acetic acid, enable N₂ and nitrogen oxide to directionally converted into ammonia gas or ammonia water, and enable the mixture of CO₂ and N₂ and the mixture of CO₂ and nitrogen oxide to be directionally converted into urea.

10. The operation method according to claim 8, wherein in the tubular penetration electrode-based flow cell reaction system, the gas duct assembly comprises a main tube and a plurality of branch tubes connected and parallel-connected with the main tube, and an outlet of the gas duct assembly is located on an opening end of each branch tube;
the gas duct assembly is a metallic member connected with the power source by a wire.

11. The operation method according to claim 8, wherein in the tubular penetration electrode-based flow cell reaction system, a first inlet of the reaction gas input tube is connected with an outlet of the first connection tube, a second inlet of the reaction gas input tube is connected with an external reaction gas source; a first electric valve, a mass flowmeter, and a gas pressure meter are disposed on the reaction gas input tube.

12. The operation method according to claim 8, wherein in the tubular penetration electrode-based flow cell reaction system, an inlet of the cathode electrolyte input tube is connected with a cathode electrolyte storage tank, and a second electric valve is disposed on the cathode electrolyte input tube.

13. The operation method according to claim 8, wherein in the tubular penetration electrode-based flow cell reaction system, an inlet of the anode electrolyte input tube is connected with an anode electrolyte storage tank, and a third electric valve and a liquid pressure meter are disposed on the anode electrolyte input tube.

14. The operation method according to claim 8, wherein in the tubular penetration electrode-based flow cell reaction system, the anode chamber is further provided with the exhaust tube to output a gas generated by reaction in the anode chamber.

15. The operation method according to claim 8, wherein in the tubular penetration electrode-based flow cell reaction system, the gas-liquid separation device is internally provided with a rotary separator to perform separation on the post-reaction gas-liquid mixture by rotation.

16. The operation method according to claim 10, wherein the multi-channel tubular penetration electrodes made of corresponding materials enable CO to be directionally converted into methane, methanol, formic acid, ethane, ethylene, ethanol, or acetic acid, enable CO₂ to be directionally converted into CO, methane, methanol, formic acid, ethane, ethylene, ethanol, or acetic acid, enable N₂ and nitrogen oxide to directionally converted into ammonia gas or ammonia water, and enable the mixture of CO₂ and N₂ and the mixture of CO₂ and nitrogen oxide to be directionally converted into urea.

17. The operation method according to claim 11, wherein the multi-channel tubular penetration electrodes made of corresponding materials enable CO to be directionally converted into methane, methanol, formic acid, ethane, ethylene, ethanol, or acetic acid, enable CO₂ to be directionally converted into CO, methane, methanol, formic acid, ethane, ethylene, ethanol, or acetic acid, enable N₂ and nitrogen oxide to directionally converted into ammonia gas or ammonia water, and enable the mixture of CO₂ and N₂ and the mixture of CO₂ and nitrogen oxide to be directionally converted into urea.

18. The operation method according to claim 12, wherein the multi-channel tubular penetration electrodes made of corresponding materials enable CO to be directionally converted into methane, methanol, formic acid, ethane, ethylene, ethanol, or acetic acid, enable CO₂ to be directionally converted into CO, methane, methanol, formic acid, ethane, ethylene, ethanol, or acetic acid, enable N₂ and nitrogen oxide to directionally converted into ammonia gas or ammonia water, and enable the mixture of CO₂ and N₂ and the mixture of CO₂ and nitrogen oxide to be directionally converted into urea.

19. The operation method according to claim 13, wherein the multi-channel tubular penetration electrodes made of corresponding materials enable CO to be directionally converted into methane, methanol, formic acid, ethane, ethylene, ethanol, or acetic acid, enable CO₂ to be directionally converted into CO, methane, methanol, formic acid, ethane, ethylene, ethanol, or acetic acid, enable N₂ and nitrogen oxide to directionally converted into ammonia gas or ammonia water, and enable the mixture of CO₂ and N₂ and the mixture of CO₂ and nitrogen oxide to be directionally converted into urea.

20. The operation method according to claim 14, wherein the multi-channel tubular penetration electrodes made of corresponding materials enable CO to be directionally converted into methane, methanol, formic acid, ethane, ethylene, ethanol, or acetic acid, enable CO₂ to be directionally converted into CO, methane, methanol, formic acid, ethane, ethylene, ethanol, or acetic acid, enable N₂ and nitrogen oxide to directionally converted into ammonia gas or ammonia water, and enable the mixture of CO₂ and N₂ and the mixture of CO₂ and nitrogen oxide to be directionally converted into urea.
